(19) United States
(12) Patent Application Publication
(10) Pub. No.: US 2018/0308187 A1
(43) Pub. Date: Oct. 25, 2018

(54) SEARCHING AND RESERVING ACCOMMODATION USING A VIRTUAL REALITY INTERFACE

(71) Applicant: VDRoom Ltd., Kfar Saba (IL)

(72) Inventors: Gal ROTEM, Petach-Tikva (IL); Michal Hubschmann Rahamim, Kfar-Saba (IL); Lance Bailey, Tel-Aviv (IL)

(21) Appl. No.: 15/831,488

(22) Filed: Dec. 5, 2017

(30) Foreign Application Priority Data
Apr. 22, 2017 (GB) 1706412.2

(51) Int. Cl. G06Q 50/12; G06F 17/30; G06T 19/00; G06F 3/0484; G06F 3/0481; G06F 3/01; G06Q 10/02

(52) U.S. Cl. CPC G06Q 50/12; G06F 17/30241; G06T 19/003; G06Q 10/02; G06F 3/04815; G06F 3/012; G06F 3/017; G06F 3/04842

(57) ABSTRACT

A system for searching and optionally reserving accommodation using a Virtual Reality (VR) interface comprising a first interface adapted to receive VR instructions from a VR user interface controlled by a user while presented with a VR presentation at a VR display, a second interface for accessing first and second storages and a processor. The first storage hosts a repository comprising a multiple layers each storing presentation data for multiple geographical areas at a respective zoom-in level. The second storage stores accommodation information of a plurality of accommodation facilities. The processor(s) is adapted to retrieve the presentation data for a certain geographical area from a layer selected according to the VR instructions, augment the presentation data to mark accommodation facility(s) identified in the certain geographical area and instruct the VR display to present the augmented presentation data added with accommodation information retrieved from the second storage for selected accommodation facility(s).

### RELATED APPLICATION

This application claims the benefit of priority of Great Britain Patent Application No. 1706412.2, filed on Apr. 22, 2017, the contents of which are incorporated herein by reference in their entirety.

### FIELD AND BACKGROUND OF THE INVENTION

The present invention, in some embodiments thereof, relates to searching and optionally reserving accommodation using a Virtual Reality (VR) user interface, and, more specifically, but not exclusively, to searching and optionally reserving accommodation using a VR user interface to navigate through a VR presentation associated with a layered repository comprising presentation data of a plurality of geographical areas in a gradual zoom-in level.

The volume of travelling and travelers is ever rising as more and more people travel from one place to another for one or more of a plurality of reasons, for example, business trips, vacations, academic purposes, research, exploration and/or the like. While travel volume increases the use of traditional means, methods and/or preference for making travel arrangements (e.g. flight/accommodations reservations, etc.), for example, using a travel agent, using written media, making phone calls and/or the like is constantly decreasing. On the other hand, using online resources on the other hand for making such travel arrangements is quickly spreading and becoming ever more simple, efficient, accessible and/or the like making it highly appealing for the end users.

Virtual reality, for example, VR, augmented reality, layered reality and/or the like have been rapidly evolving in recent times. VR technology, systems and applications are widely spreading and may target various, diverse needs, applications, markets and/or the like, ranging from medical procedures training and practice applications through industry/military training applications to trading, shopping, leisure and gaming applications.

Due to its inherent advantages, the VR technology may be a realistic, efficient and hence highly appealing platform for interacting with human users. Presenting the user with a visual presentation, either realistic, synthetic and/or a combination thereof, optionally coupled with an audible, tactile and/or other sensory simulation, may allow simulating realistically for the user a plurality of diverse scenes, scenarios, events, situations, cases, conditions and/or the like. To maintain an effective simulation, the user input may be captured using wearable VR sensors, for example, inertial sensors that may capture movement, motion, gestures and/or the like initiated by the user.

### SUMMARY OF THE INVENTION

According to a first aspect of the present invention there is provided a system for searching and booking accommodation using a virtual reality (VR) display, comprising:

a first interface adapted to receive VR navigation instructions from a VR user interface controlled by a user during a VR presentation to the user on a VR display;

a second interface for accessing a first storage and a second storage, the first storage hosts a layered repository comprising a plurality of layers, each of the plurality of layers stores presentation data for a plurality of geographical areas at a respective zoom-in level, the second storage stores accommodation information of a plurality of accommodation facilities; and

one or more processors coupled to the first and second interfaces, the processor(s) is adapted to execute code, the code comprising:
code instructions to retrieve the presentation data for a certain one of the plurality of geographical areas from one of the plurality of layers selected according to the VR navigation instructions,
code instructions to instruct the VR display to present the presentation data,
code instructions to augment the presented presentation data to mark a location of one or more of the plurality of accommodation facilities identified in the certain geographical area, and
code instructions to instruct the VR display to present the accommodation information retrieved from the second storage for one or more of the marked accommodation facilities selected according to the VR navigation instructions.

Using the VR user interface may allow a simple, intuitive and highly efficient interface for the user to search for accommodation at a desired location. Constructing the VR pretention as a leveled VR presentation in which each level presents the geographical area at a respective zoom-in level may simplify the interaction with the user as the user may efficiently navigate through the leveled VR presentation to quickly concentrate on the geographical area of interest. Providing a hands free interface may relief the user of using intermediate user interface devices such as, for example, a keyboard, a pointing device, a touch screen and/or the like as may be used by the existing methods. Moreover, maintaining and using the layered repository to store the presentation data for each level of the leveled VR presentation may be significantly more efficient, for example, reduce latency, reduce communication resources, reduce network bandwidth and/or the like. Furthermore, retrieving the accommodation information, for example, availability, pricing, facilities, contact information and/or the like from the second storage which is associated with the selected accommodation facility(s) and is therefore up to date may assure that the information is current and accurate.

According to a second aspect of the present invention there is provided a computer implemented method of searching and booking accommodation using a virtual reality (VR) display, comprising:

using one or more processors adapted to execute code, the code is adapted for:
retrieving presentation data for a certain one of a plurality of geographical areas from a selected one of a plurality of layers of a layered repository hosted by a first storage, the selected layer is selected according to VR navigation instructions received from a VR user interface controlled by a user during a VR presentation to the user on a VR display, each of the plurality of layers stores the presentation data for the plurality of geographical areas at a respective zoom-in level;
instructing the VR display to present the presentation data;
augmenting the presented presentation data to mark a location of one or more of a plurality of accommodation facilities identified in in the certain geographical area; and
instructing the VR display to present accommodation information of the one or more accommodation facilities selected according to the VR navigation instructions, the accommodation information is retrieved from a second storage storing the accommodation information of the plurality of accommodation facilities.

In an optional implementation form of the first and/or second aspects, the code further comprises code instructions to transmit one or more reservation requests for reserving one or more rooms selected in the accommodation facility(s) according to the VR navigation instructions of the user who uses the accommodation information to select the selected room(s). The reservation request(s) is transmitted to one or more reservation services associated with the selected accommodation facility(s). The efficient hands free VR interface may allow simple and efficient interaction with the user to guide the user through the reservation process.

In an optional implementation form of the first and/or second aspects, the code further comprises code instructions to present one or more adjacent facility visual marking in association with one or more of the selected accommodation facilities. The adjacent facility visual marking(s) indicates the accommodation information is available for one or more accommodation facilities adjacent to the selected accommodation facility(s). Highlighting additional facilities adjacent to the selected accommodation facility may allow the user to easily search, identify, locate and/or navigate to additional facilities which are located near his geographical area of interest.

In a further implementation form of the first and/or second aspects, the accommodation information comprises availability information, pricing information, facilities information, contact information, a guest review, one or more images of the accommodation facility(s) and/or one or more images of one or more rooms in the accommodation facility(s). The accommodation information may be essential for the user to make a decision in selecting and/or reserving his accommodation based on, for example, the accommodation availability, pricing and/or the like.

In an optional implementation form of the first and/or second aspects, the accommodation information further comprises a structural presentation of one or more of the accommodation facilities through which the user navigates using the VR navigation instructions. The structural presentation may significantly enhance the visual conception of the user regarding the structure and/or layout of the accommodation facility(s) such that the user may base his selection of a room for example on his specific preferences.

In an optional implementation form of the first and/or second aspects, the accommodation information further comprises a room view of one or more rooms in one or more of the accommodation facilities. The room view may significantly enhance the visual conception of the user regarding the room, its structure, layout, furniture and/or the like such that the user may base his selection on his specific preferences.

In a further implementation form of the first and/or second aspects, the room view comprises a virtual tour in one or more of the rooms. The virtual tour may further enhance the visual conception of the user regarding the room, its structure, layout, furniture and/or the like such that the user may get a realistic feel of the room.

In a further implementation form of the first and/or second aspects, the room view comprises an outdoor view consisting of one or more outdoor images as viewed from one or more of the rooms. The outdoor view may be a major criterion for the user for selecting his accommodation. Presenting the outdoor view as seen from the selected room may therefore allow the user to better chose the room according to his specific preferences.

In an optional implementation form of the first and/or second aspects, the code further comprises code instructions to present one or more adjacent room visual markings in association with one or more of the selected rooms. The adjacent room visual marking(s) indicates the accommodation information is available for one or more rooms adjacent to the selected room(s). Highlighting additional rooms adjacent to the selected room may allow the user to easily search, identify, locate and/or navigate to rooms which are located near the currently presented and viewed room.

In an optional implementation form of the first and/or second aspects, the code further comprises code instructions to present a user interface used by one or more users to upload at least some of the accommodation information. Providing means for the users to upload the accommodation information, in particular the images of the accommodation facilities may allow an extensive imagery database which may be used to create a smooth, detailed and/or realistic virtual tour in the accommodation facilities and their surroundings. The extended imagery database may further allow efficient identification of adjacent rooms and/or accommodations facilities in order to present the adjacent room visual markings and/or the adjacent facility markings accordingly.

In an optional implementation form of the first and/or second aspects, the code further comprises code instructions to present a lower layer visual marking in association with one or more of the plurality of geographical areas presented in the VR presentation consisting of the presentation data retrieved from a current layer of the plurality of layers. The lower layer visual marking indicates that the presentation data is available for one or more of the geographical areas in a subsequent lower layer of the plurality of layers. Marking geographical areas which may be zoomed into may further simplify the user in navigating through the leveled VR presentation as the user may be aware in advance, i.e. while exploring a current zoom-in level, of geographical areas into which he may further zoom-in.

In a further implementation form of the first and/or second aspects, the VR user interface comprises one or more wearable inertial sensors adapted to capture movement of one or more of: a head of the user and a hand of the user. The VR navigation instructions are identified by analyzing sensory data obtained from one or more of the inertial sensors. The wearable inertial sensors may accurately capture navigation gestures and/or movement initiated by the user in order to allow efficient navigation while significantly improving the user experience.

In a further implementation form of the first and/or second aspects, the VR user interface comprises one or more inertial sensors adapted to capture movement of a client device used by the user. The VR navigation instructions are identified by analyzing sensory data obtained from one or more of the inertial sensors. The inertial sensors integrated in the client device may accurately capture navigation gestures and/or movement initiated by the user in order to allow efficient navigation while significantly improving the user experience even when using a simplified VR interface such as the flat display of the mobile device and its integrated inertial sensors.

In a further implementation form of the first and/or second aspects, the VR display comprises a head mounted VR display (HMD) worn by the user and/or a flat display of a client device used by the user. The head mounted VR display presents a 3 Dimensional (3D) VR presentations to the user and the flat display presents a 2 Dimensional (2D) VR presentations to the user. The accommodation search and reservation system may be applicable for high end device where the user uses an HMD and is presented with a 3D VR presentation as well as for lower end environments in which a 2D VR presentation is presented on a flat display of a client device used by the user, for example, a Smartphone, a tablet and/or the like.

In a further implementation form of the first and/or second aspects, the processor(s) is integrated in a client device used by the user. The client device comprising one or more communication interfaces to communicate with the VR display. This may allow flexibility in designing, constructing and/or adapting the system to operate with and possible take advantage of computing resources, for example, processing resources, storage resources, communication resources and/or the like available in a client device used by the user, for example, a Smartphone, a tablet and/or the like thus significantly reducing the cost of the system. In other implementations, the processor(s) as well as one or more of the first and/or second interfaces and/or the inertial sensors may be integrated in the VR display thus achieving a highly integrated compact system which may significantly improve the user experience and/or increase operational efficiency of the system.

In a further implementation form of the first and/or second aspects, the presentation data comprises synthetic presentation data, one or more images of one or more of the plurality of geographical areas and/or a combination thereof. This may allow flexibility in constructing the VR presentation presented to the user at the VR display as various presentation data sources may be used. Moreover, combining (fusing) the synthetic presentation data with imagery data may produce an improved presentation which may significantly improve the user experience.

In a further implementation form of the first and/or second aspects, the first storage comprises a local storage and/or a remote storage. The local storage is accessible to the one or more processors through a local interface provided by the first interface and the remote storage is accessible to the one or more processors through a communication interface provided by the first interface. This may allow flexibility in the system design, construction and/or use as the system may be adapted for operation under different conditions. For example, using the remote storage may significantly reduce cost of the system as storage resources may be significantly reduced. However in case of limited network connectivity, the system may be adapted to retrieve the presentation data from a local storage.

In a further implementation form of the first and/or second aspects, the plurality of accommodation facilities include short term accommodation facilities, long term accommodation facilities and/or other points of interest. By adapting the system searching and optionally reserving accommodation in a plurality of accommodation facilities such as the short term accommodation facilities, long term accommodation facilities and/or other points of interest, the system may be applied for various diverse applications, goals, implementation and/or target market segments.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

Implementation of the method and/or system of embodiments of the invention can involve performing or completing selected tasks manually, automatically, or a combination thereof. Moreover, according to actual instrumentation and equipment of embodiments of the method and/or system of the invention, several selected tasks could be implemented by hardware, by software or by firmware or by a combination thereof using an operating system.

For example, hardware for performing selected tasks according to embodiments of the invention could be implemented as a chip or a circuit. As software, selected tasks according to embodiments of the invention could be implemented as a plurality of software instructions being executed by a computer using any suitable operating system. In an exemplary embodiment of the invention, one or more tasks according to exemplary embodiments of method and/or system as described herein are performed by a data processor, such as a computing platform for executing a plurality of instructions. Optionally, the data processor includes a volatile memory for storing instructions and/or data and/or a non-volatile storage, for example, a magnetic hard-disk and/or removable media, for storing instructions and/or data. Optionally, a network connection is provided as well. A display and/or a user input device such as a keyboard or mouse are optionally provided as well.

### BRIEF DESCRIPTION OF THE SEVERAL VIEWS OF THE DRAWING(S)

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 is a flowchart of an exemplary process of searching and reserving accommodation using a VR user interface for navigating through a VR presentation, according to some embodiments of the present invention;

FIG. 2 is a schematic illustration of an exemplary system for searching and reserving accommodation using a VR user interface for navigating through a VR presentation, according to some embodiments of the present invention;

FIG. 3 is a schematic illustration of an exemplary VR display used for navigating through a VR presentation to search and book accommodation, according to some embodiments of the present invention;

FIG. 4 is a schematic illustration of an exemplary layered repository associated with a VR presentation used for searching and reserving accommodation, according to some embodiments of the present invention; and

FIG. 5A and FIG. 5B are schematic illustrations of exemplary virtual tour presentations augmented with adjacent room visual markings, according to some embodiments of the present invention.

### DESCRIPTION OF SPECIFIC EMBODIMENTS OF THE INVENTION

The present invention, in some embodiments thereof, relates to searching and optionally reserving accommodation using a Virtual Reality (VR) user interface, and, more specifically, but not exclusively, to searching and optionally reserving accommodation using a VR user interface to navigate through a VR presentation associated with a layered repository comprising presentation data of a plurality of geographical areas in a gradual zoom-in level.

According to some embodiments of the present invention, there are provided methods, systems and computer program products for searching and optionally reserving (booking) accommodation using a VR user interface for navigating through a VR presentation. The user may select the type of accommodation he is interested in, for example, short term accommodation facilities (e.g. hotels, motels, lodges, resorts, inns, houses, camping sites, etc.), long term accommodation (e.g. real-estate properties, time share properties, etc.) and/or the like. The accommodation may further include points of interest, for example, tourist attractions, restaurants, landmarks and/or the like.

A user may use a VR user interface comprising a VR display and one or more VR sensors, for example, an inertial sensor and/or the like monitoring and capturing movement of the user, for example, a head movement, a hand movement, a bodily movement and/or the like. The VR display may be a 3D (stereoscopic) VR display, for example, a Head Mounted Display (HMD), a stereoscopic goggles display and/or the like. The VR display may also be a standard flat display integrated in a client device used by the user, for example, a computer, a mobile device (e.g. a Smartphone, a tablet etc.) and/or the like.

The VR display may be used to present to the user a VR presentation of one or more of a plurality of geographical areas while the user may navigate through the VR presentation by initiating one or more navigation gestures, for example, moving his head, moving one or more of his hands, moving his body, moving the client device and/or the like. The navigation gestures may be captured by one or more of the VR sensors and the sensory data obtained from the VR sensor(s) may be analyzed to identify the navigation gesture(s) and map them to one or more VR navigation instructions. Optionally, one or more of the VR sensors may be integrated in the VR display, for example, the head mounted 3D VR display may integrate one or more inertial sensors adapted to monitor and capture head movements of the user. In another example, the client device used by the user may integrate one or more inertial sensors adapted to monitor and capture movements of the mobile device.

The VR presentation and/or the interaction with the user may be controlled by the VR display itself and/or by the client device communicating with the VR user interface, i.e. with the VR display and/or the VR sensors.

The VR presentation may constitute a plurality of levels where in each level the geographical area may be presented in a respective zoom-in level. The zoom-in level relates to the size of the FOV presented by the VR presentation where a smaller FOV presents a smaller geographical area at a higher detail level and vice versa, a larger FOV presents a larger geographical area at a lower detail level.

The VR presentation may be associated with a layered repository hosted by a first storage resource comprising one or more local and/or remote storage resources. The local storage resources may include, a storage resource (e.g. hard drive, a memory card, etc.) integrated in the client device used by the user and/or integrated in the VR display. The first storage may further comprise one or more remote storage resources, for example, a remote server, a remote service, a cloud storage, a cloud service and/or the like accessible from the client device of the user and/or from the VR display. Moreover, the layered repository hosted by the remote storage resources may be a distributed repository divided between multiple remote storage resources and/or services.

The layered repository comprising a plurality of layers may be utilized through one or more implementations, for example, a database, a mapping service and/or the like. Each layer of the layered repository may be associated with a respective level of the VR presentation such that each layer may store presentation data depicting the geographical areas at the zoom-in level of the respective level of the VR presentation. The presentation data may include synthetic presentation data of one or more of the geographical areas, for example, a map, an animated presentation and/or the like. Additionally and/or alternatively, the presentation data may include one or more images of one or more of the geographical areas. Optionally, the synthetic presentation data and the image(s) may be combined, for example, fused, overlaid, augmented and/or the like for one or more of the geographical areas.

The user may navigate within the level(s) and/or between levels of the VR presentation by initiating the VR navigation instructions to select a desired geographical area. In response, an appropriate layer in the layered repository may be selected which corresponds to the selected level in the VR presentation and the respective presentation data of the selected geographical area may retrieved and presented by the VR display. For example, the user may navigate starting from a top level of the VR presentation, for example, a world view, to select a continent, navigate in a subsequent lower layer (level), for example, a continent, to select a country, navigate in a subsequent lower layer, for example, a country, to select a city, navigate in a subsequent lower layer, for example, a city to select a neighborhood and so on.

Optionally, a lower layer visual marking (indication may be added and/or associated with one or more geographical areas to indicate that higher zoom-in (i.e. higher resolution) presentation data is available for the associated geographical area(s) in a subsequent lower layer of the layered repository.

At one or more of its zoom-in levels, the VR presentation may be augmented to mark one or more accommodations facilities identified in the presented geographical area. Applying the VR navigation instructions, the user may select one or more of the accommodations facilities. In response to the selection, accommodation information may be retrieved from a second storage comprising one or more storage resources, in particular storage resources and/or services associated with the selected accommodation facility(s), for example, a database of the selected accommodation facility(s), a website of the selected accommodation facility(s), a reservation service of the selected accommodation facility(s), a reservation service (e.g. Booking(dot)com, TripAdvisor, Expedia, Airbnb, HomeAway, etc.) offering the selected accommodation facility(s), and/or the like.

The accommodation information may include, for example, availability information, pricing information, facilities information, contact information, guest reviews, one or more images of the accommodation facility(s), one or more images of the room(s), one or more images of outdoor scenery as viewed from the room(s) and/or the like. The user, through the VR navigation instructions, may select one or more room(s) in one or more of the accommodation facilities. Optionally, the VR presentation may include a structural presentation of one or more of the selected accommodation facilities, for example, a layout of the accommodating facility, a floor layout and/or the like to allow the user to navigate through the presented structure and select one or more rooms.

Optionally, at least some of the accommodation information, specifically, the image(s) of one or more of the accommodation facilities may be upload to the second storage by one or more users. The users, for example, guests, travelers, visitors, employees, owners and/or the like who visited one or more accommodation facilities, for example, the short term accommodation facility, the long term accommodation facility and/or the other point of interest may upload one or more indoor and/or outdoor images of the visited accommodation facility(s) to the second storage. The users may optionally be offered an incentive, for example, publication, advertisement, a gift, a discount and/or the like to motivate the users to upload the images.

Optionally, the VR presentation may be adapted to construct and present to the user a virtual tour, in particular a 3D virtual tour in the selected accommodation facility(s) and/or the selected room(s), for example, a virtual tour in one or more interior spaces and/or an exterior spaces of the selected accommodation facility(s), in a surroundings of the selected accommodation facility(s), in one or more of the selected room(s) and/or the like. The virtual tour may further present a surroundings of the selected accommodation facility(s), a scenery as viewed from the selected accommodation facility(s) and/or from the selected room(s) and/or the like. Moreover, the virtual tour may be an interactive virtual tour in which the user may initiate one or more of the VR navigation instructions to move, for example, travel, turn, change point of view, etc. in the virtually presented accommodation facility and/or room.

Optionally, the VR presentation may be adapted to present one or more adjacent room visual markings (hotspots) in association with the selected room(s). The adjacent room visual marking indicates that the presentation data, specifically the accommodation information is available for one or more rooms adjacent to the selected room(s). Moreover, the user may initiate one or more VR navigation instructions to select one or more of the adjacent room visual markings to navigate to the adjacent room(s) associated with the selected adjacent room visual marking(s). The user may naturally navigate back and/or forth between the adjacent rooms by selecting their respective adjacent room visual marking. Similarly, in case the user is interested in the long term accommodation facilities and/or in the other points of interest, the VR presentation may be adapted to present one or more adjacent facility visual markings in association with the selected accommodation facility. The adjacent facility visual marking indicates that the presentation data, specifically the accommodation information is available for one or more long term accommodation facilities and/or in the other points of interest adjacent to the selected accommodation facility(s).

Applying the VR navigation instructions, the user may further reserve (book) one or more of the rooms according to the accommodation information, for example, reserve a room in a hotel, reserve a table at a restaurant, register for an organized tour and/or the like. Through the VR presentation, the user may proceed through the reservation process, for example, specify a payment method, receive a confirmation and/or the like.

Searching and optionally reserving (booking) accommodation using the VR interface, i.e. the VR display and the VR sensors to present and interact with the user through a VR presentation, in particular a leveled VR presentation associated with a layered repository storing the presentation data may introduce significant advantages compared to existing methods and/or applications for searching and reserving accommodation.

First, as VR becomes more common and widely used, the VR user interfaces may be taken advantage of to offer the user a simple, intuitive and highly efficient process for searching and optionally reserving accommodation at a desired location. Constructing the VR pretention as a leveled VR presentation in which each level presents the geographical area at a respective zoom-in level may simplify the interaction with the user as the user may efficiently navigate through the leveled VR presentation to quickly concentrate on the geographical area of interest. Providing a hands free interface may relief the user of using intermediate user interface devices such as, for example, a keyboard, a pointing device, a touch screen and/or the like as may be used by the existing methods.

Moreover, maintaining and using the layered repository to store the presentation data for each level of the leveled VR presentation may significantly enhance the process for retrieving the presentation data and constructing the VR presentation presented to the user. Each layer in the layered repository may be optimized to include respective presentation data, for example, according to the respective VR presentation level, according to one or more geographical areas and/or the like. Access to the optimized layered repository may therefore be significantly more efficient, for example, reduce latency, reduce communication resources, reduce network bandwidth and/or the like.

Furthermore, retrieving the accommodation information from the second storage associated with the selected accommodation facility(s) may assure that the information relating to the selected accommodation facility(s) is up to date such that the user is provided with accurate information for his selected accommodation facility(s). Such accommodation information, for example, availability, pricing, facilities availability and/or the like may be essential for the user to make a decision in selecting and/or reserving his accommodation based on, for example, the accommodation availability, pricing and/or the like.

Is addition, providing means for the users to upload the accommodation information, in particular the images of the accommodation facilities may allow an extensive imagery database which may be used to create a smooth, detailed and/or realistic virtual tour in the accommodation facilities and their surroundings. Moreover, the extensive imagery database may be used to efficiently identify and present the user with the adjacent room visual markings and/or the adjacent facility markings (hotspots).

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages.

The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

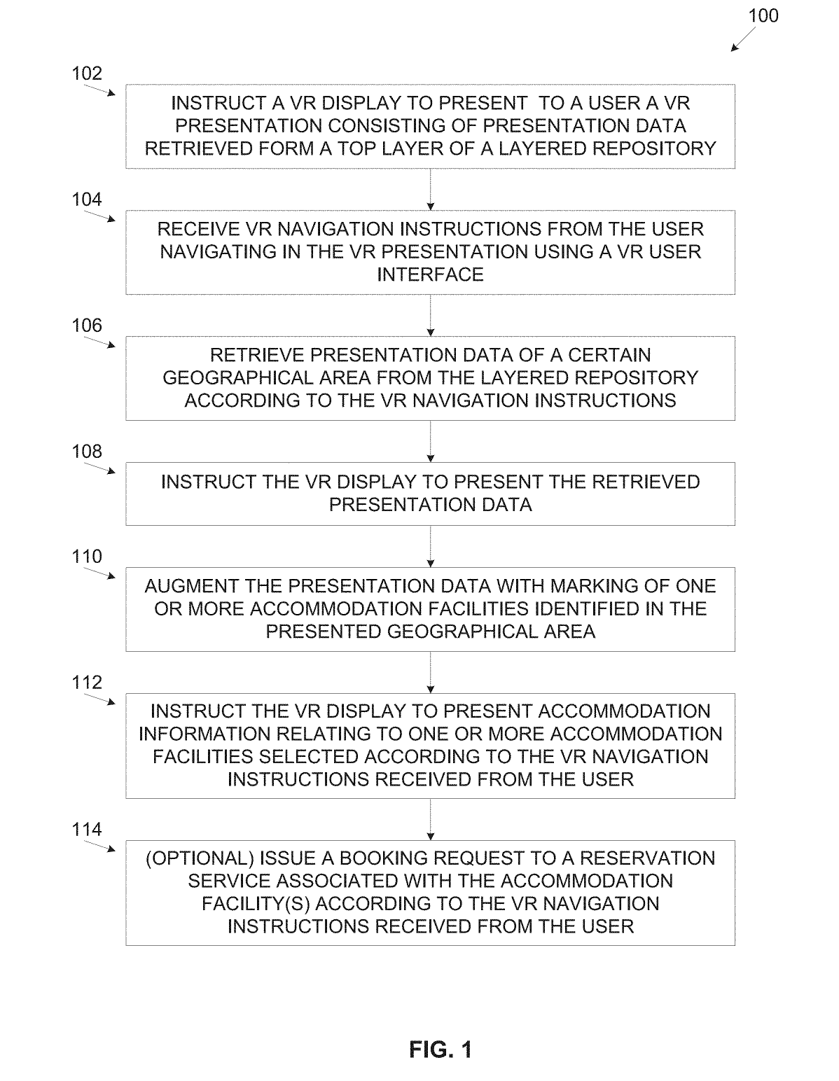

Referring now to the drawings, FIG. 1 is a flowchart of an exemplary process of searching and reserving accommodation using a VR user interface for navigating through a VR presentation, according to some embodiments of the present invention. A process 100 may be executed to interact with a user for searching and optionally reserving accommodation in one or more accommodations facilities. The user may use a VR user interface comprising a VR display, for example, a head mounted 3D (stereoscopic) VR display and one or more VR sensors, for example, an inertial sensor and/or the like monitoring and capturing movement of the user, for example, a head movement, a hand movement, a bodily movement and/or the like.

The VR display may be used to present to the user a VR presentation of one or more of a plurality of geographical areas while the user may navigate through the VR presentation by initiating one or more navigation gestures, for example, moving his head, moving one or more of his hands, moving his body, moving the client device and/or the like. The navigation gestures may be mapped to VR navigation instructions by analyzing sensory data obtained from the VR sensor(s) capturing the navigation gestures.

The VR presentation may constitute a plurality of levels where in each level the geographical area may be presented in a respective zoom-in level. The zoom-in level relates to the size of the FOV presented by the VR presentation where a smaller FOV presents a smaller geographical area at a higher detail level and vice versa, a larger FOV presents a larger geographical area at a lower detail level. The VR presentation may be associated with a layered repository, for example, a database, a mapping service and/or the like comprising a plurality of layers. Each layer of the layered repository may be associated with a respective level of the VR presentation and hence each layer may store presentation data depicting the geographical areas at the zoom-in level of the respective level of the VR presentation. The user may initiate VR navigation instructions to navigate in the level and/or between levels of the VR presentation to select a desired geographical area. The VR navigation commands may be translated to selecting an appropriate layer in the layered repository corresponding to the selected level in the VR presentation.

At one or more of the levels, i.e. the zoom-in levels, the VR presentation may be augmented to mark one or more accommodations facilities identified in the presented geographical area. Applying the VR navigation instructions, the user may select one or more of the accommodations facilities. In response to the selection, accommodation information may be retrieved from a second storage comprising one or more storage resources associated with the selected accommodation facility(s). The accommodation information may include, for example, availability information, pricing information, facilities information, contact information, guest reviews, one or more images of the accommodation facility(s), one or more images of the room(s), one or more images of outdoor scenery as viewed from the room(s) and/or the like.

Applying the VR navigation instructions, the user may further reserve (book) one or more of the rooms according to the accommodation information.

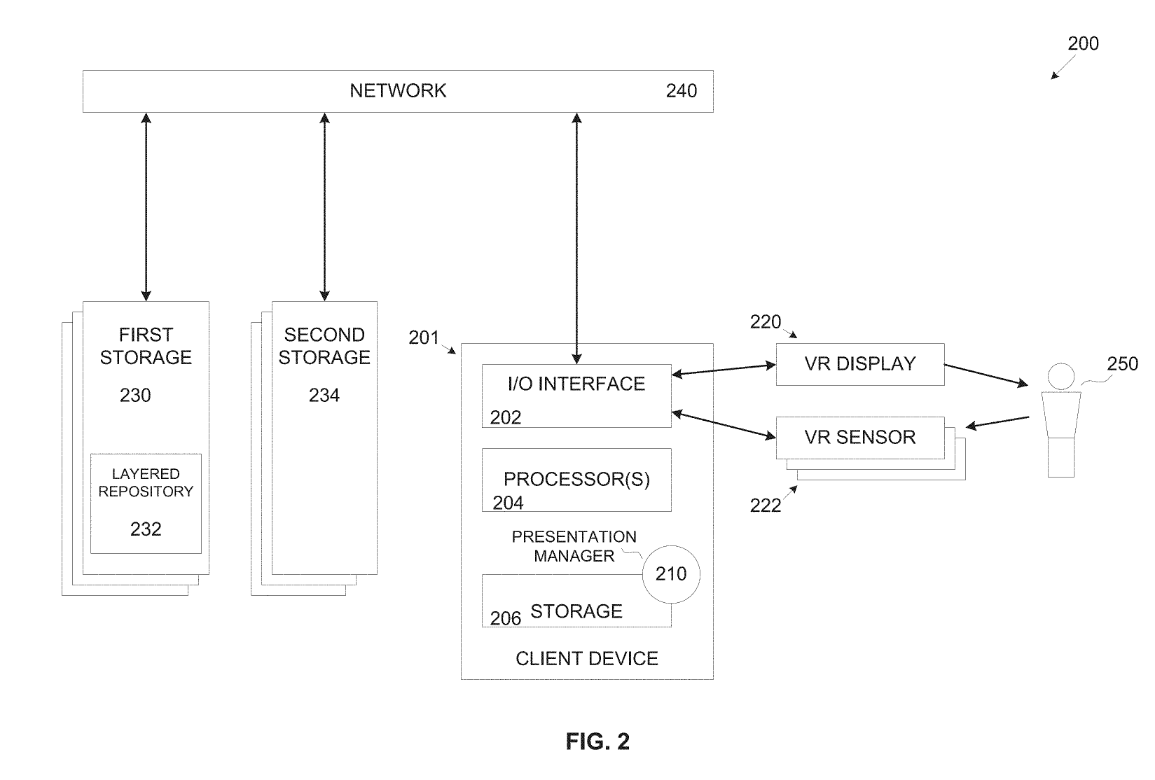

Reference is also made to FIG. 2, which is a schematic illustration of an exemplary system for searching and reserving accommodation using a VR user interface for navigating through a VR presentation, according to some embodiments of the present invention. An exemplary system 200 for searching and reserving (booking) accommodation using a VR user interface includes a client device 201, for example, smartphone, a Tablet, a computer, a laptop and/or the like adapted to communicate with a VR user interface comprising a VR display 220 and one or more VR sensors 222 for interacting with a user 250.

The client device 201 comprises an Input/Output (I/O) interface 202, a processor 204 and storage 206. The I/O interface 202 may include one or more wired and/or wireless interfaces for communicating with the VR display 220 and/or the VR sensor(s) 222, for example, a wireless Local area Network (WLAN, e.g. Wi-Fi) interface, a Bluetooth interface, a Radio Frequency (RF) interface, an analog interface, a Universal Serial Bus (USB) interface, a network interface, a proprietary interface and/or the like. The I/O interface 202 may further include one or more wired and/or wireless network interfaces for connecting to one or more networks 240, for example, a Local area Network (LAN), a Wide area Network (WAN), a Metropolitan Area Network (MAN), a WLAN, a cellular network, and/or the internet to facilitate communication with more or more remote locations and/or resources.

The processor 204, homogenous or heterogeneous, may include one or more processors arranged for parallel processing, as clusters and/or as one or more multi core processors. The storage 206 may include one or more non-transitory persistent storage devices, for example, a hard drive, a Flash array and/or the like. The storage 206 may also include one or more volatile devices, for example, a Random Access Memory (RAM) component and/or the like.

The storage 206 may store one or more software modules, for example, an OS, an application, a tool, an agent, a service, a script and/or the like each comprising a plurality of program instructions that may be executed by the processor 204 from the storage 206. For example, the processor 204 may execute a presentation manager 210 software module for controlling a VR presentation presented to the user 250 by the VR display 220 and receiving the VR navigation instructions initiated by the user 250 as captured by the VR sensor(s) 222. The presentation manager 210 may further instruct the VR display 220 to create a 3D VR presentation in order to create a more realistic presentation allowing the user 250 to perceive and/or navigate in the VR presentation more efficiently.

The VR display 220 may include a 3D (stereoscopic) VR display, for example, a 3D HMD, a stereoscopic goggles display and/or the like. The VR display 220 may also include a standard flat display, specifically a display of the client device 201, for example, a computer/laptop screen, a mobile device screen (e.g. a Smartphone, a tablet etc.) and/or the like. The 3D stereoscopic VR display 220 may support a 3D stereoscopic VR presentation which includes visual depth presentation. The 3D stereoscopic VR display 220 may naturally support an interactive presentation which is adapted according to VR instructions received from the user 250. The flat VR display 220 on the other hand may not support the 3D stereoscopic VR presentation but may still support the interactive presentation which is adapted according to VR instructions received from the user 250.

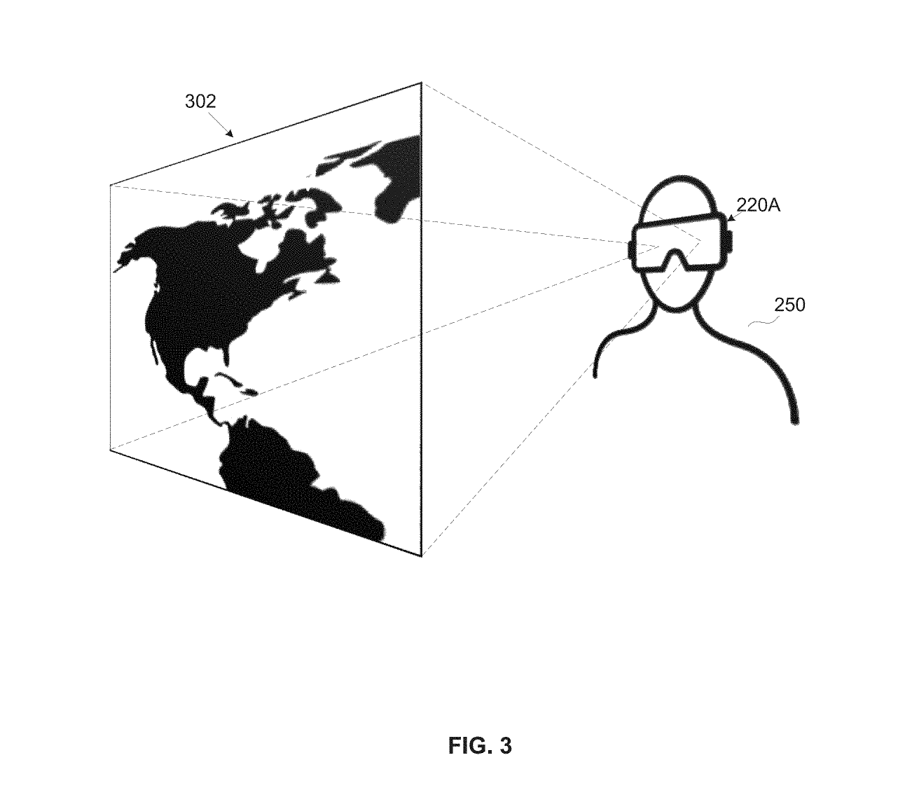

Reference is now made to FIG. 3, which is a schematic illustration of an exemplary VR display used for navigating through a VR presentation to search and book accommodation, according to some embodiments of the present invention. A VR display such as the VR display 220 may be adapted to present to a user such as the user 250 a VR presentation 302, for example, a VR presentation, a 3D VR presentation, a stereoscopic presentation comprising depth simulation and/or the like. An exemplary VR display 220A may include an HMD VR display worn by the user 250 such that VR presentation 302 is presented on the inside surface of the VR display 220 and visible to the user 250.

Reference is made once again to FIG. 1 and FIG. 2.

The VR sensor(s) 222 may include one or more inertial sensors, for example, an accelerometer, a gyroscope, an Inertial Measurement Unit (IMU) and/or the like adapted to monitor and capture movements of the user 250, for example, head movements, hand movements, bodily movements and/or the like. The VR sensor(s) 222 may be worn, for example, worn, placed, attached, coupled and/or the like by the user 250.

In some embodiments of the present invention, one or more components of the client device 201, specifically the I/O interface 202 and/or part thereof, the processor 204 and/or the storage 206 may be integrated in the VR display 220. For example, the presentation manager 210 may be executed by the processor 204 of the VR display 220 from the storage 206 of the VR display 220. In another example, the presentation manager 210 executed by the VR display 220 may connect to the network 240 through the I/O interface 202 of the VR display 220. In another example, the presentation manager 210 may be executed by the processor 204 of the VR display 220 and communicate with the client device 201 through a local communication interface, for example, Wi-Fi provided by the I/O interface 202 of the VR display 220. The client device 201 may communicate with one or more remote resources over the network 240, for example, the cellular network and thus serve as a relay, a gateway, a bridge and/or the like providing the VR display 220 with network connectivity to the network 240. Moreover, in such embodiments one or more of the VR sensors 222 may be integrated with the VR display 220. For example, in case the VR display 220 is utilized by the head mounted VR display, one or more VR sensors 222 adapted to monitor and capture head movements of the user 250 may be integrated in the VR display 220.

In some embodiments of the present invention, the VR display 220 is integrated in the client device 201, such that the VR display 220 is utilized by the screen of a client device 201, for example, the Smartphone, the tablet, the computer, the laptop and/or the like. In such embodiments one or more of the VR sensors 222 may be integrated with the client device 201. For example, one or more sensors typically available in the client device 201, for example, an accelerometer, a gyroscope and/or the like may be used as the VR sensors 222.

The presentation manager 210 may access a first storage 230 hosting a layered repository 232 comprising presentation data of a plurality of geographical areas. The first storage 230 may be a remote storage resource accessible to the presentation manager 210 over the network 240, for example, a server, cloud storage, cloud service and/or the like. Moreover the first storage 230 may be a distributed storage comprising a plurality of storage resources each hosting one or more parts of the layered repository 232. However, in some embodiments of the present invention, the first storage 230 may be utilized by a local storage resource, for example, the storage 206 accessible locally to the presentation manager 210 through a local interface, for example, a memory interface.

The layered repository 232 may include, for example, a database, a proprietary service and/or the like comprising the presentation data of the geographical areas, i.e. depicting the geographical areas. Additionally and/or alternatively, the layered repository 232 may be utilized by one or more global and/or public services, for example, a mapping service (e.g. google maps, street view, etc.), a geographical imagery service (e.g. google earth, etc.) and/or the like.

The presentation data available from the layered repository 232 may include synthetic presentation data of one or more of the geographical areas, for example, a map, an animated presentation and/or the like. The presentation data may also include one or more images of one or more of the geographical areas. Optionally, the presentation data may include a combination of the synthetic presentation data and the image(s), for example, a fusion, an overlay, an augmentation and/or the like to create combined presentation data of one or more of the geographical areas.

The layered repository 232 may be arranged in a plurality of layers corresponding to the levels of the VR presentation such that each layer comprises the presentation data for the geographical areas at a different zoom-in level which gradually increases from a top layer towards a bottom layer of the plurality of layers. As such each subsequent lower layer of the layers of the layered repository 232 may comprise a more detailed, higher resolution presentation data of the geographical areas. For example, the top layer of the layered repository may include presentation data of a world view and each subsequent lower layer may include a gradually higher zoom-in level of the geographical areas, for example, a continent, a country, a city, a town, a geographical region and/or the like. The layered repository 232 may further include location data of a plurality of accommodation facilities, for example, a hotel, a motel, a lodge, a resort, an inn, a house, a camping site and/or the like. The accommodation facilities may further include long term accommodation, for example, real-estate properties, time share properties and/or the like. The accommodation facilities may also relate to other points of interest, for example, tourist attractions, restaurants, landmarks and/or the like.

The presentation manager 210 may further communicate over the network 240 with a second storage 234 storing accommodation information relating to one or more of the accommodations facilities. The second storage 234 may include one or more storage resources associated with the accommodation facilities, for example, a database of the accommodation facility(s), a website of the accommodation facility(s), a reservation service of the accommodation facility(s), a reservation service such as, for example, Booking(dot)com, TripAdvisor, Expedia, Airbnb, HomeAway, and/or the like offering accommodation in the accommodation facility(s). The accommodation information may include, for example, availability information, pricing information, facilities information, guest reviews, one or more images of the accommodation facility(s), one or more images of the room(s), one or more images of outdoor scenery as viewed from the room(s) and/or the like.

The second storage 234 may further include storage resources and/or storage data associated with long term accommodation facilities, for example, real-estate properties, time share properties and/or the like. For example, the second storage 234 may include one or more databases, services, websites and/or the like of one or more real-estate and/or time share agents, services, offices and/or the like. The second storage 234 may also include storage resources and/or storage data associated with other points of interest, for example, tourist attractions, restaurants, landmarks and/or the like. For example, the second storage 234 may include one or more one or more databases, services, websites and/or the like of one or restaurants, organized tours agents, museums, municipal authorities and/or the like.

Optionally, the presentation manager 210 includes a user interface for uploading at least some of the accommodation information, in particular the images of one or more of the short term accommodation facilities, the long term accommodation facilities and/or the other points of interest. Using the user interface of the presentation manager 210, one or more users, for example, users, for example, guests, travelers, visitors, employees, owners and/or the like who visited one or more accommodation facilities, for example, the short term accommodation facility, the long term accommodation facility and/or the other point of interest may upload one or more indoor and/or outdoor images of the visited accommodation facility(s). The presentation manager 210 may store the uploaded images and/or other accommodation information to the second storage 234 for later use.

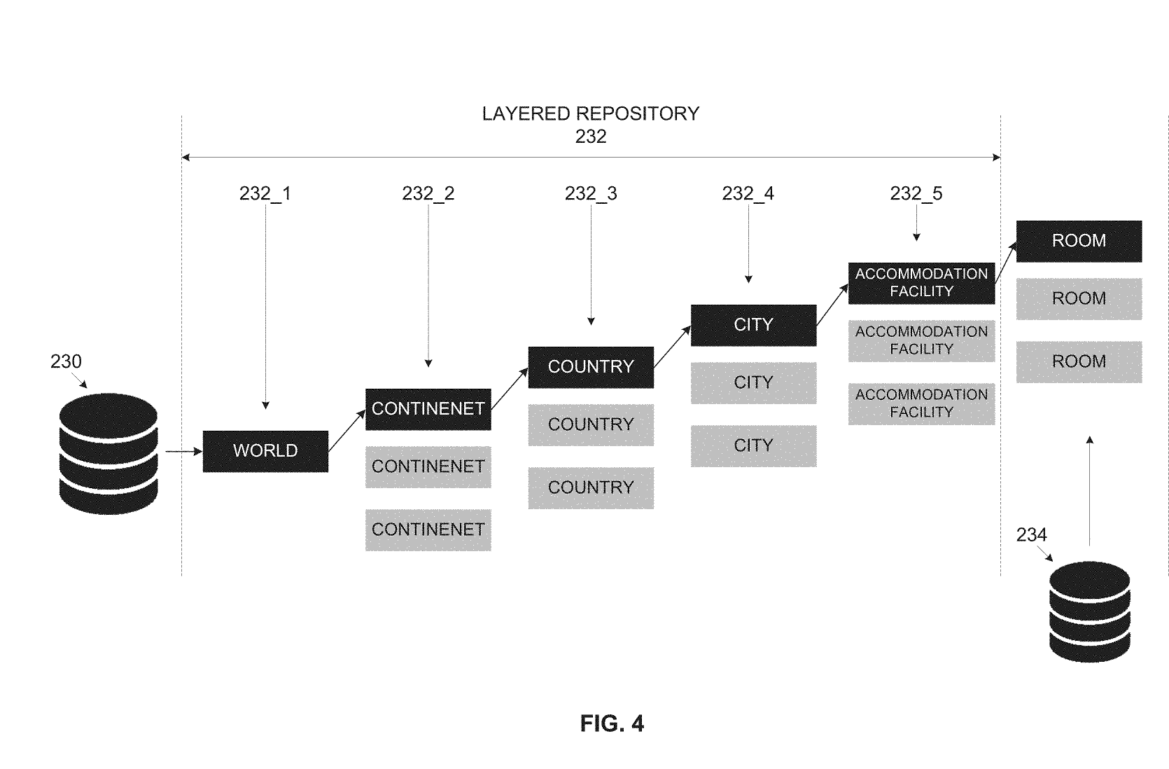

Reference is now made to FIG. 4, which is a schematic illustration of an exemplary layered repository associated with a VR presentation used for searching and reserving accommodation, according to some embodiments of the present invention. A layered repository such as the layered repository 232 hosted by a first storage such as the first storage 230 may include a plurality of layers 232_n, for example, a layer 232_1, a layer 232_2, a layer 232_3, a layer 232_4 and/or a layer 232_5. Each layer 232_n is associated with a respective level of a VR presentation such as the VR presentation 302 presented to a user such as the user 250 using a VR display such as the VR display 220. As such each layer 232_n is associated with a respective zoom-in level of the geographical areas presented to the user 250 and stores presentation data of the geographical areas at the respective zoom-in level. For example, the layer 232_1 stores presentation data at a world resolution, the layer 232_2 stores presentation data at a continent resolution, the layer 232_3 stores presentation data at a country resolution and the layer 232_4 stores presentation data at a city resolution. The layer 232_5 may store accommodation facilities data, in particular a location of one or more of the accommodation facilities. The layer 232_5 may further store the accommodation facilities data correlated with the geographical area presented using the presentation data available from the layer 232_4 (city resolution). Therefore, the presentation data of a continent selected using the presentation data of the layer 232_1 (world resolution) may be available from the layer 232_2. Similarly, the presentation data of a country selected using the presentation data of the layer 232_2 (continent resolution) may be available from the layer 232_3 and the presentation data of a city selected using the presentation data of the layer 232_3 (country resolution) may be available from the layer 232_4. The presentation data presented through the VR presentation 302 may be augmented to mark the location of one or more accommodation facilities located in the selected city using the location data available from the layer 232_5. Moreover, a second storage such as the second storage 234 may store the accommodation information for the accommodation facilities marked in the VR presentation 302.

Reference is made once again to FIG. 1 and FIG. 2.

As shown at 102, the process 100 may start with the presentation manager 210 instructing the VR display 220 to present to the user 250 a top layer of a VR presentation such as the VR presentation 302. The top layer, for example, a world view may serve as an entry point for the user 250 using the VR user interface to navigate through the VR presentation 302 in order to select one or more geographical areas of interest. The presentation manager 210 may retrieve presentation data used to create the VR presentation 302 from a layered repository such as the layered repository 232, specifically from a top layer of the layered repository 232 such as the layer 232_1.

As shown at 104, the presentation manager 210 receives VR navigation instructions from the user 250 using the VR user interface, specifically the VR sensor(s) 222. The user 250 may be wearing one or more of the VR sensor(s) 222 and may inject input to the presentation manager 210 by initiating one or more navigation gestures, for example, movements, gestures and/or the like which may be monitored and captured by the VR sensor(s) 222. The VR sensor(s) 222 may generate sensory data depicting the captured navigation gestures initiated by the user 250. The presentation manager 210 may obtain the sensory data from the VR sensor(s) 222 and analyze it to identify one or more navigation gestures. For example, based on analysis of the sensory data obtained from one or more VR sensors 222 attached to the head of the user 250, the presentation manager 210 may identify one or more gestures, for example, a head sideways movement, a head up/down movement, a head forward/backward movement, no head movement for a predefined time period (freeze) and/or the like. In another example, based on the analysis of the sensory data obtained from one or more VR sensors 222 attached to the hand(s) of the user 250, the presentation manager 210 may identify one or more gestures articulated by the hand(s) of the user 250, for example, a hand sideways movement, a hand up/down movement, a hand forward/backward movement, no hand(s) movement for a predefined time period (freeze) and/or the like. In another example, based on the analysis of the sensory data obtained from one or more VR sensors 222 integrated in the client device 201, the presentation manager 210 may identify one or more movements of the client device 201 which may be initiated by the user 250, for example, a sideways movement, an up/down movement, a forward/backward movement, no movement for a predefined time period (freeze) and/or the like.

Optionally, one or more of the VR sensors 222 conduct the analysis of the sensory data themselves to identify the navigation gesture(s) initiated by the user 250 and output an indication of the identified navigation gesture(s) to the presentation manager 210.

The presentation manager 210 may map (correlate) the identified navigation gestures to predefined VR navigation instructions associated with one or more of the navigation gestures. For example, the head sideways movements may be correlated with a horizontal lateral movement of the VR presentation 302 (left/right) in order to move a certain geographical area to a center of the VR presentation 302. In another example, the head up/down movements may be correlated with vertical lateral movement of the VR presentation 302 (up/down). In another example, the head forward/backward movements may be correlated with a zoom-in and zoom-out of the layered VR presentation accordingly such that the VR presentation 302 may be adjusted to present another layer of the layered VR presentation, i.e. an increased and/or decreased resolution of the selected geographical area. In another example, the head no movement (freeze) for the predefined time period (e.g. 3 seconds) may be correlated with a selection of an object (e.g. location, geographical area, accommodation facility, etc.) centered in the VR presentation 302. For example, assuming the user 250 is interested in Europe while the VR presentation 302 currently presents the world view, the user 250 may initiate VR navigation instructions to center Europe in the VR presentation 302. In another example, assuming the user 250 is interested in France while the VR presentation 302 currently presents a view of Europe, the user 250 may initiate VR navigation instructions to zoom into France.

As shown at 106, the presentation manager 210 may retrieve presentation data to adjust the VR presentation 302 according to the identified VR navigation instructions. The presentation manager 210 may retrieve the presentation data from the respective layer of the layered repository 232 associated with the level of the layered VR presentation indicated by the user 250. In case of horizontal and/or vertical lateral movements as indicated by the VR navigation instructions with no change in the zoom-in level (resolution), the presentation manager 210 may retrieve the corresponding presentation data from the same layer 232_n of the layered repository 232 currently selected. However in case of zoom-in and/or zoom-out as indicated by the VR navigation instructions, the presentation manager 210 may retrieve the corresponding presentation data from another layer 232_n of the layered repository 232 selected according to the zoom-in level (i.e. higher/lower) indicated by the VR navigation instructions.

For example, assuming the VR presentation 302 currently presents Europe at continent resolution using data retrieved from the layer 232_2. Assuming Germany is currently presented at the center of the VR presentation 302 and the VR navigation instructions indicate westward (e.g. left) lateral movement towards France. In such case the presentation manager 210 may retrieve the required presentation data of France from the same layer 232_2 and adjust the VR presentation 302 to present France in the center. In another example, assuming the VR presentation 302 currently presents Europe at continent resolution using data retrieved from the layer 232_2. Assuming France is presented in the center of the VR presentation 302 and the VR navigation instructions indicate zooming-in. In such case the presentation manager 210 may retrieve the required country level presentation data from the layer 232_3 and adjust the VR presentation 302 to present France at country resolution.

As shown at 108, the presentation manager 210 may instruct the VR display 220 to present the adjusted VR presentation 302 using the presentation data retrieved by the presentation manager 210 from the appropriate layer 232_n of the layered repository 232.

Optionally, in one or more of the VR presentation levels presented by the VR presentation 302, the presentation manager 210 may instruct the VR display 220 to present a lower layer (level) visual marking in association with one or more of the geographical areas presented in the current VR presentation 302. The visual marking may indicate that a lower layer VR presentation is available for the indicated geographical area(s). This means that assuming the presentation data for the current VR presentation 302 is retrieved from a layer 232_n of the layered repository 232, presentation data at a higher zoom-in level is available for the indicated geographical area(s) in a lower layer 232_n+1. This may allow the user 250 to identify that a higher zoom-in level may be selected for the indicated geographical area(s) thus allowing for a finer resolution VR presentation 302 of the indicated geographical area(s). For example, assuming the current VR presentation 302 presents Italy in a country resolution using data retrieved by the presentation manager 210 from the layer 232_3 of the layered repository 232, one or more cities, for example, Rome, Milan, Venice, etc. may be indicated with the lower layer visual marking indicating that presentation data at a higher zoom-in level, i.e. city resolution may be available for these cities in the layer 232_4. The visual marking may further be presented only in response to a selection of the user 250 initiating one or more VR navigation instructions, for example, hovering over a certain geographical area presented in the VR presentation 302, centering the certain geographical area in the VR presentation 302 and/or the like.

As shown at 110, the presentation manager 210 may instruct the VR display 220 to augment the VR presentation 302 to mark one or more of the accommodation facilities as selected by the VR navigation instructions initiated by the user 250. The user 250 may select the type of accommodation facilities of interest by initiating one or more VR navigation instructions, for example, to navigate in a selection menu presented in the VR presentation 302. For example, assuming the user 250 indicates he is interested in short term accommodation facilities, the presentation manager 210 may instruct the VR display 220 to augment the VR presentation 302 to mark one or more of the short term accommodation facilities, for example, a hotel, a motel, a lodge, a resort, an inn, a house, a camping site and/or the like located in the geographical area presented in the VR presentation 302. Based on the interest indicated by the user 250, the presentation manager 210 may further instruct the VR display 220 to augment the VR presentation 302 to mark one or more other points of interest, for example, a long term accommodation facility (e.g. a real-estate property, a time share property, etc.), a tourist attraction, a restaurant, a landmark and/or the like. Specifically, the presentation manager 210 may augment the VR presentation 302 to mark the geographical location of the accommodation facility(s) and/or the point of interest(s) in the VR presentation 302. The presentation manager 210 may retrieve accommodation facilities data, in particular the geographical location of the accommodation facility(s) and/or of the point of interest(s) from the layered repository 232. For example, the presentation manager 210 may retrieve accommodation facilities data from a specific layer of the layered repository 232 such as the layer 232_5 which stores the accommodation facilities data. The accommodation facilities data stored in the layer 232_5 may be correlated with the geographical area presented using the presentation data available from one or more other layers 232_n of the layered repository 232, for example, the layer 232_3 (country resolution), the layer 232_4 (city resolution) and/or the like.

For brevity, the term accommodation facilities used herein after collectively refers to the short term accommodation facilities, the long term accommodation facilities and the other points of interest.

The presentation manager 210 may instruct the VR display 220 to mark the location of one or more of one or more of the accommodation facilities in one or more of the levels of the VR presentation presented in the VR display 302, i.e. in one or more zoom-in levels. For example, the location of the accommodation facility(s) may be marked in a city resolution VR presentation 302, in a neighborhood resolution VR presentation 302, in a street resolution VR presentation 302 and/or the like. Naturally, the higher the zoom-in level, the more accurate the location of the accommodation facility(s) may be marked in the VR presentation 302.

As shown at 112, the presentation manager 210 may receive VR navigation instructions initiated by the user 250 to select one or more of the accommodation facilities marked in the VR presentation 302. In response to the VR navigation instructions, the presentation manager 210 may access a second storage such as the second storage 234 to retrieve accommodation information for the selected accommodation facility(s). The second storage 234 may typically be associated with the selected accommodation facility(s). For example, assuming the user 250 is interested in the short term accommodation facility(s), the second storage 234 may include, for example, a database of the selected accommodation facility(s), a website of the selected accommodation facility(s), a reservation service of the selected accommodation facility(s), an online reservation service (e.g. Booking(dot)com, TripAdvisor, Expedia, Airbnb, HomeAway, etc.) offering the selected accommodation facility(s), and/or the like. In another example, assuming the user 250 is interested in the long term accommodation facility(s), the second storage 234 may include, for example, a database, a service, a website and/or the like of one or more real-estate and/or time share agents, services, offices and/or the like. In another example, assuming the user 250 is interested in the other points of interest(s), the second storage 234 may include, for example, a database, a service, a website and/or the like of one or restaurants, organized tours agents, museums, municipal authorities and/or the like.

Similarly to the term accommodations facility, for brevity, the term accommodation information relates to the short term accommodation facilities, the long term accommodation facilities and/or the other points of interest.

The accommodation information may include, for example, availability and/or pricing information for one or more rooms offered by the selected accommodation facility(s). As the second storage 234 is associated with the selected accommodation facility(s), the second storage 234 may provide up to date accommodation information, specifically the availability information and/or the pricing information for the rooms offered by the selected accommodation facility(s). Moreover, the presentation manager 210 may retrieve the availability and/or pricing information from a plurality of reservation services, for example, Booking(dot)com, TripAdvisor, Expedia, Airbnb, HomeAway, and/or the like and present it to the user 250 thus allowing the user 250 to determine a preferred reservation service according to the availability and/or pricing offered by each of the reservation services.

The accommodation information may include facilities information on the facilities offered by the selected accommodation facility(s), attractions information for attractions located in proximity to the selected accommodation facility(s), guest reviews written by guests who stayed in the selected accommodation facility(s) in the past and/or the like. The accommodation information may also include contact information, for example, a website Uniform Resource Locator (URL), a phone number, an address and/or the like for use by the user 250.

The accommodation information may include one or more images of the selected accommodation facility(s), for example, an image of an interior space of the selected accommodation facility(s), an image of an exterior space of the selected accommodation facility(s), an image of a facility of the selected accommodation facility(s) and/or the like. The presentation manager 210 may further use one or more of the images to construct and/or instruct the VR display 220 to construct a virtual tour, specifically a 3D virtual tour in the selected accommodation facility(s) and present the virtual tour on the VR display 220. The virtual tour may present, for example, one or more interior spaces and/or an exterior spaces of the selected accommodation facility(s), a surroundings of the selected accommodation facility(s), a scenery as viewed from the selected accommodation facility(s) and/or the like. Moreover, the presentation manager 210 may construct and/or instruct construction of the 3D virtual tour using the images retrieved from the second storage 234, specifically images uploaded to the second storage 234 by one or more of the users, for example, the guests, the travelers, the visitors, the employees, the owners and/or the like who visited the selected accommodation facility(s). Furthermore, the virtual tour may be an interactive virtual tour in which the user 250 may initiate one or more VR navigation instructions to move, for example, travel, turn, change point of view, etc. in the virtually presented accommodation facility.

Optionally, the presentation manager 210 retrieves from the second storage 234 presentation data for a structural presentation of one or more of the selected accommodation facilities, for example, a layout of the selected accommodating facility(s), a floor layout and/or the like. After retrieving the presentation data, the presentation manager 210 may instruct the VR display 220 to present the structural presentation. Moreover, the structural presentation may be a 3D VR presentation, a VR stereoscopic presentation and/or the like. Navigating through the structural presentation the user 250 may select one or more rooms.

The presentation manager 210 may receive VR navigation instructions initiated by the user 250 to select one or more rooms in one or more of the selected accommodation facilities. In particular, the user 250 may issue VR navigation instructions to select room(s) available in the selected accommodation facility(s).

Optionally, the presentation manager 210 retrieves, from the second storage 234, presentation data for one or more of the selected rooms, for example, facilities information, room view comprising one or more images of the room, outdoor view comprising one or more images of scenery as viewed from the room (e.g. from a balcony, from a terrace, form a yard, etc.) and/or the like. The presentation manager 210 may further use one or more of the images to construct and/or instruct the VR display 220 to construct a virtual tour, specifically a 3D virtual tour in the selected room(s) and present the virtual tour on the VR display 220. Moreover, the virtual tour may be an interactive virtual tour in which the user 250 may initiate one or more VR navigation instructions to move, for example, travel, turn, change point of view, etc. in the virtually presented room.

Optionally, the presentation manager 210 instructs the VR display 220 to present one or more adjacent room visual markings (hotspots) in association with the selected room(s), i.e. while presenting the currently selected room(s). The adjacent room visual marking indicates that the presentation data, specifically the accommodation information is available for one or more rooms adjacent to the selected room(s). Specifically, the presentation manager 210 may control the VR display 220 to present the adjacent room visual marking(s) in the direction and/or geographical location of the adjacent room(s) with respect to the selected room(s). For example, during a virtual tour in a certain selected room presented to the user 250 through the VR display 220, the presentation manager 210 may augment the virtual tour presentation to include one or more adjacent room visual markings. The presentation manager 210 may set the location of the adjacent room visual marking(s) in the presentation at the estimated direction and/or geographical location of one or more available rooms adjacent to the currently presented (selected) room(s). In particular, presentation manager 210 may augment the virtual tour presentation to place the adjacent room visual marking(s) according to the current point of view of the user 250. The presentation manager 210 may further augment the virtual tour presentation to adjust the location of the adjacent room visual marking(s) according to the changes in the point of view of the user 250. Moreover, the presentation manager 210 may identify and present the adjacent room visual markings using the images retrieved from the second storage 234, specifically images uploaded to the second storage 234 by one or more of the users, for example, the guests, the travelers, the visitors, the employees, the owners and/or the like who visited the selected accommodation facility(s).

Optionally, the user 250 may initiate one or more VR navigation instructions to select one or more of the adjacent room visual markings in order to navigate to the adjacent room(s) associated with the selected adjacent room visual marking(s). The user 250 may navigate back and/or forth between the adjacent rooms by selecting their respective adjacent room visual marking.

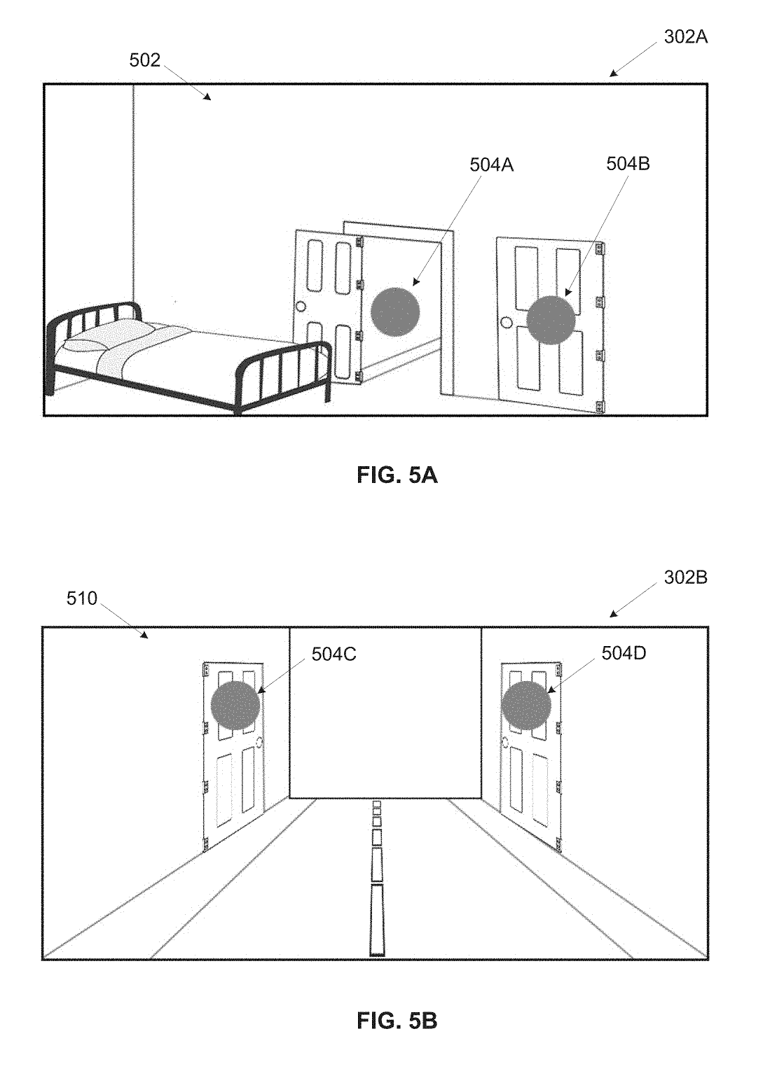

Reference is now made to FIG. 5A and FIG. 5B which are schematic illustrations of exemplary virtual tour presentations augmented with adjacent room visual markings, according to some embodiments of the present invention.

As seen in FIG. 5A, a presentation manager such as the presentation manager 210 may instruct a VR display such as the VR display 220 to present an exemplary virtual tour presentation 302A such as the VR presentation 302 to a user such as the user 250. The virtual tour presentation 302A presents an interior of a selected room 502 to the user 250. The presentation manager 210 may instruct the VR display 220 to augment the virtual tour presentation 302A, for example, add one or more adjacent room visual markings 504 to indicate the user 250 that accommodation information is available for one or more rooms adjacent to the selected room 502. For example, an adjacent room visual marking 504A may be added to indicate that the accommodation information is available for a first room located to the left of the main door of the selected room 502. In another example, an adjacent room visual marking 504B may be added to indicate that the accommodation information is available for a second room located to the right of the main door of the selected room 502 and has a connecting door to the selected room 502.

As seen in FIG. 5B, the presentation manager 210 may instruct the VR display 220 to present to the user 250 an exemplary virtual tour presentation 302B presenting an interior of a corridor 510 in a certain accommodation facility, for example, a hotel, a motel, a resort and/or the like selected by the user 250. The presentation manager 210 may instruct the VR display 220 to augment the virtual tour presentation 302B, for example, add one or more adjacent room visual markings 504 to indicate the user 250 that accommodation information is available for one or more rooms adjacent to the corridor 510. For example, an adjacent room visual marking 504C may be added to indicate that the accommodation information is available for a third room located to the left of the corridor 510 with respect to the current point of view of the user 250. In another example, an adjacent room visual marking 504D may be added to indicate that the accommodation information is available for a fourth room located to the right of the corridor 510 with respect to the current point of view of the user 250.

Reference is made once again to FIG. 1 and FIG. 2.

Optionally, in case the user 250 is interested in the long term accommodation and/or in the other point(s) of interest, the presentation manager 210 may instruct the VR display 220 to present one or more adjacent facility visual markings (hotspots) indicating that accommodation information is available for one or more other long term accommodation facility(s) and/or other point(s) of interest adjacent to the currently selected (presented) accommodation facility and/or point of interest. For example, assuming that according to the instructions of the presentation manager 210, the VR presentation 302 currently presents a certain restaurant, the presentation manager 210 may instruct the VR display 220 to adjust the VR presentation 302 to include one or more adjacent facility visual markings associated with one or more other restaurants adjacent to the certain restaurant. In another example, assuming that according to the instructions of the presentation manager 210, the VR presentation 302 currently presents a certain real estate property offered for sale, the presentation manager 210 may instruct the VR display 220 to adjust the VR presentation 302 to include one or more adjacent facility visual markings associated with one or more other real estate properties offered for sale which are adjacent to the certain real estate property. Moreover, the presentation manager 210 may identify and present the adjacent facility visual markings using the images retrieved from the second storage 234, specifically images uploaded to the second storage 234 by one or more of the users, for example, the guests, the travelers, the visitors, the employees, the owners and/or the like who visited the selected accommodation facility(s).

As shown at 114 which is an optional step, the presentation manager 210 may issue, i.e. transmit a reservation (booking) request for making a reservation at the selected accommodation facility. For example, assuming the process 100 is conducted to search and reserve one or more rooms in a short term accommodation facility, the presentation manager 210 may transmit the reservation request to reserve one or more rooms selected according to the VR navigation instructions initiate by the user 250. The presentation manager 210 may transmit the reservation request to one or more reservation services associated with one or more of the selected accommodation facilities, i.e. reservation services offering accommodation in the accommodation facility(s), for example, a reservation service of the selected accommodation facility(s), an online reservation service such as, for example, Booking(dot)com, TripAdvisor, Expedia, Airbnb, HomeAway, and/or the like. The presentation manager 210 may further serve the user 250 to issuing VR navigation instructions to interact with the reservation service(s) and make the reservations. In another example, assuming the user 250 indicated he is interested in, for example, searching and reserving a table in a selected restaurant, searching and registering for a selected guided tour and/or the like. The presentation manager 210 may, for example, transmit the reservation request to an online reservation services associated with the selected restaurant. Similarly, in case of the guided tour, the presentation manager 210 may, for example, transmit the reservation request to an online reservation services associated with the selected guided tour.

Naturally, the process 100 may be repeated multiple times as the user 250 may navigate back and forth through the VR presentation 302, i.e. initiate VR navigation instructions to zoom-in and/or zoom-out of the current VR presentation 302 and/or navigate laterally within the same presentation layer. In response to the identified VR navigation instructions, the presentation manager 210 may retrieve the presentation data used for the VR presentation 302 from the appropriate layer of the layered repository 232.

It is expected that during the life of a patent maturing from this application many relevant systems, methods and computer programs will be developed and the scope of the terms VR user interface and VR display are intended to include all such new technologies a priori.

As used herein the term “about” refers to ±10%.

The terms “comprises”, “comprising”, “includes”, “including”, “having” and their conjugates mean “including but not limited to”. This term encompasses the terms “consisting of” and “consisting essentially of”.

The phrase “consisting essentially of” means that the composition or method may include additional ingredients and/or steps, but only if the additional ingredients and/or steps do not materially alter the basic and novel characteristics of the claimed composition or method.

As used herein, the singular form “a”, “an” and “the” include plural references unless the context clearly dictates otherwise. For example, the term “a compound” or “at least one compound” may include a plurality of compounds, including mixtures thereof.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

The word “exemplary” is used herein to mean “serving as an example, an instance or an illustration”. Any embodiment described as “exemplary” is not necessarily to be construed as preferred or advantageous over other embodiments and/or to exclude the incorporation of features from other embodiments.

The word “optionally” is used herein to mean “is provided in some embodiments and not provided in other embodiments”. Any particular embodiment of the invention may include a plurality of “optional” features unless such features conflict.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

What is claimed is:

1. A system for searching and reserving accommodation using a virtual reality (VR) interface, comprising:
a first interface adapted to receive VR navigation instructions from a VR user interface controlled by a user during a VR presentation to said user on a VR display;
a second interface for accessing a first storage and a second storage, said first storage hosts a layered repository comprising a plurality of layers, each of said plurality of layers stores presentation data for a plurality of geographical areas at a respective zoom-in level, said second storage stores accommodation information of a plurality of accommodation facilities; and
at least one processor coupled to said first and second interfaces, said at least one processor is adapted to execute a code, said code comprising:
code instructions to retrieve said presentation data for a certain one of said plurality of geographical areas from one of said plurality of layers selected according to said VR navigation instructions,
code instructions to instruct said VR display to present said presentation data,
code instructions to augment said presented presentation data to mark a location of at least one of said plurality of accommodation facilities identified in said certain geographical area, and
code instructions to instruct said VR display to present said accommodation information retrieved from said second storage for at least one accommodation facility selected according to said VR navigation instructions.

2. The system of claim 1, wherein said code further comprising code instructions to transmit at least one reservation request for reserving at least one room selected in said at least one accommodation facility according to said VR navigation instructions of said user who uses said accommodation information to select said at least one selected room, said at least one reservation request is transmitted to at least one reservation service associated with said at least one accommodation facility.

3. The system of claim 1, wherein said code further comprising code instructions to present at least one adjacent facility visual marking in association with said at least one selected accommodation facility, said at least one adjacent facility visual marking indicates said accommodation information is available for at least one accommodation facility adjacent to said at least one selected accommodation facility.

4. The system of claim 1, wherein said accommodation information comprises at least one member of a group consisting of: availability information, pricing information, facilities information, contact information, a guest review, at least one image of said at least one accommodation facility and at least one image of at least one room in said at least one accommodation facility.

5. The system of claim 4, wherein said accommodation information further comprising a room view of at least one room in said at least one accommodation facility.

6. The system of claim 5 wherein said room view comprises a virtual tour in said at least one room.

7. The system of claim 5, wherein said room view comprises an outdoor view consisting of at least one outdoor image as viewed from said at least one room.

8. The system of claim 4, wherein said code further comprising code instructions to present at least one adjacent room visual marking in association with at least one selected room, said at least one adjacent room visual marking indicates said accommodation information is available for at least one room adjacent to said at least one selected room.

9. The system of claim 1, wherein said accommodation information further comprising a structural presentation of said at least one accommodation facility through which said user navigates using said VR navigation instructions.

10. The system of claim 1, wherein said code further comprising code instructions to present a user interface used by at least one user to upload at least some of said accommodation information.

11. The system of claim 1, wherein said code further comprising code instructions to present a lower layer visual marking in association with at least one of said plurality of geographical areas presented in said VR presentation consisting of said presentation data retrieved from a current layer of said plurality of layers, said lower layer visual marking indicates that said presentation data is available for said at least one geographical area in a subsequent lower layer of said plurality of layers.

12. The system of claim 1, wherein said VR user interface comprises at least one wearable inertial sensor adapted to capture movement of at least one of: a head of said user and a hand of said user, said VR navigation instructions are identified by analyzing sensory data obtained from said at least one inertial sensor.

13. The system of claim 1, wherein said VR user interface comprises at least one inertial sensor adapted to capture movement of a client device used by said user, said VR navigation instructions are identified by analyzing sensory data obtained from said at least one inertial sensor.

14. The system of claim 1, wherein said VR display is a member of a group consisting of: a head mounted VR display worn by said user and a flat display of a client device used by said user, said head mounted VR display presents a 3 Dimensional (3D) said VR presentations to said user.

15. The system of claim 1, wherein said at least one processor is integrated in a client device used by said user, said client device comprising at least one communication interface to communicate with said VR display.

16. The system of claim 1, wherein said presentation data comprises at least one member of a group consisting of: a synthetic presentation data, at least one image of at least one of said plurality of geographical areas and a combination thereof.

17. The system of claim 1, wherein said first storage is a member of a group consisting of: a local storage and a remote storage, said local storage is accessible to said at least one processor through a local interface provided by said first interface and said remote storage is accessible to said at least one processor through a communication interface provided by said first interface.

18. The system of claim 1, wherein said plurality of accommodation facilities include a plurality of members of a group consisting of: short term accommodation facilities, long term accommodation facilities and other points of interest.

19. A computer implemented method of searching and reserving accommodation using a virtual reality (VR) interface, comprising:
using at least one processor adapted to execute a code, said code is adapted for:
retrieving presentation data for a certain one of a plurality of geographical areas from a selected one of a plurality of layers of a layered repository hosted by a first storage, said selected layer is selected according to VR navigation instructions received from a VR user interface controlled by a user during a VR presentation to said user on a VR display, each of said plurality of layers stores said presentation data for said plurality of geographical areas at a respective zoom-in level;
instructing said VR display to present said presentation data;
augmenting said presented presentation data to mark a location of at least one of a plurality of accommodation facilities identified in in said certain geographical area; and
instructing said VR display to present accommodation information for at least one accommodation facility selected according to said VR navigation instructions, said accommodation information is retrieved from a second storage storing said accommodation information of said plurality of accommodation facilities.
